(19) United States
(12) Patent Application Publication
(10) Pub. No.: US 2021/0192426 A1
(43) Pub. Date: Jun. 24, 2021

(54) ROSTER SCHEDULING AND TASK DISPATCHING SYSTEM FOR GATE STAFF

(71) Applicant: Hangzhou PL-solution Information Technology Co., Ltd., Hangzhou (CN)

(72) Inventors: Yu YU, Hangzhou (CN); Suwei WANG, Hangzhou (CN); Ji CHEN, Suzhou (CN); Guoquan SUN, Hangzhou (CN); Xuedong HE, Hangzhou (CN)

(73) Assignee: Hangzhou Pi-solution Information Technology Co., Ltd., Hangzhou (CN)

(21) Appl. No.: 17/177,531

(22) Filed: Feb. 17, 2021

Related U.S. Application Data
(63) Continuation of application No. PCT/CN2020/121479, filed on Oct. 16, 2020.

(30) Foreign Application Priority Data
Nov. 29, 2019 (CN) 201911195725.X

(51) Int. Cl. G06Q 10/06

(52) U.S. Cl. CPC G06Q 10/063116; G06Q 10/06393; G06Q 10/063112; G06Q 10/06316

(57) ABSTRACT

A scheduling planning and dispatching system for gate staff includes: a flight management module, a resource planning module, a rostering module, a real-time dispatching module, a statistical analysis module and a task bidding module. The business process of the dispatching system includes: importing flight information in combination with guarantee standards (business rules) and historical data experience; generating a flight guarantee task; forecasting the overall task load and reasonably making a rostering plan; generating a dispatching plan on the same day; performing anomaly monitoring on the flight plan; correspondingly adjusting the dispatching plan according to the actual feedback of abnormal monitoring; releasing a dispatching result; and statistically analyzing the data as historical data experience.

### CROSS-REFERENCE TO RELATED APPLICATION

This application is a continuation of International Application No. PCT/CN2020/121479, filed on Oct. 16, 2020, which is based upon and claims priority to Chinese Patent Application No. 201911195725.X, filed on Nov. 29, 2019, the entire contents of which are hereby incorporated by reference.

### TECHNICAL FIELD

This application relates to the field of airport ground command and schedule, in particular to a roster scheduling and task dispatching system for gate staff.

### BACKGROUND

The rapid increase of flights and passenger trips and the uncertainty of flight on time performance have brought unprecedented opportunities and challenges to the ground service of airlines. How to effectively ensure the intelligent scheduling and dispatching of relevant departments and staffs of airport ground service is a problem that must be studied and paid attention to.

In the patent entitled “System For Flight Ground Service Command and Schedule” (Application No.: 201110037968.8, Application Publication Date: Jun. 15, 2011), a system for flight turnaround service command and schedule is disclosed, which uses broadband wireless communication network, wireless handheld data terminal equipment used by ground staff and wireless vehicle-mounted data terminal equipment installed on special vehicles. The equipment ensures real-time bidirectional communication of data, voice, video, positioning and other information with the flight turnaround monitor center, so that the schedule center can comprehensively monitor all flight guarantee service processes and track service resources, release KPI report and schedule various resources in real time. This disclosure can realize pre-planning, fine scheduling, whole process monitoring and quantitative management of ground services, and achieve the goals of improving flight operation efficiency, employee work efficiency and utilization of special vehicle.

The aforementioned patent is not able to generate the optimal real-time dispatching solutions which affect the on time performance of flights and employee utilization rate, and make less contribution to the intelligent ground services and the optimization of resource allocation.

### SUMMARY

In order to solve the above problems, according to some embodiments of the present disclosure, a roster scheduling and task dispatching system for gate staff is provided, which can dispatch gate staff in real time, provide detailed plan for gate service scheduling, balance the resources allocation among peak and trough demands and improve the utilization of resources.

The technical scheme of this disclosure is as follows: a roster scheduling and task dispatching system, including:

a flight management module, configured to adjust gate boarding tasks, display flight lists, and generate notification and alarm for important flight information changed;

a resource planning module, configured to forecast and plan the gate boarding tasks and human resource requirements, select and optimize shift rotations;

a rostering module, configured to perform automatic roster scheduling for resources by optimization algorithms based on demand of task quantity and other regulatory constraints, to improve fairness and rationality of the scheduling and reduce labor intensity and error rate of scheduling;

a real-time dispatching module, configured to perform real-time assignments for ground service tasks at boarding gate based on dynamic flight data and preset service standards, and perform real-time task dispatch and compliance inspection for available resources through the optimization algorithms;

a statistical analysis module, configured to meet requirements of daily report customization, statistical data query and analytics of airline ground services; and

a bidline module, configured to meet requirements of “task bidding” for employees across positions meeting post qualification requirements, and motivates staff.

Preferably, the dispatching system obtains a full snapshot of flight data released by data platform of airlines on the current day, obtains an incremental data of flight changes every one minute, and automatically adjusts gate boarding tasks based on the changes of key flight information; and the dispatching system provides a comprehensive flights search and positioning tool used in combination with various conditions to select and show the flight lists quickly and conveniently. The key flight information includes scheduled take-off and landing time, estimated take-off and landing time, actual take-off and landing time, fleet type, aircraft type, boarding gate information, aircraft stand information, international or domestic attributes of flight, flight origin, flight destination, flight failure information and key flight information. The flight search and positioning tool is able to search flights by keywords and the combination e.g., aircraft type, airline code, departure station, arrival station, aircraft stand, boarding gate, departure arrival information, international and domestic grouping, flight status, etc.

Preferably, the steps for realizing functions of the resource planning module include: reasonably forecasting and planning gate boarding tasks and human resource requirements in a certain period according to flight plans, demand guarantee level and historical operation data; forming a variety of scheduling shift models according to a demand forecasting curve, scheduling rules and the number of employees, and conducting a comparative analysis of shifts through simulation, and screening and optimizing shift plans as the scheduling input.

Preferably, the functions of the rostering module include generation and release of a scheduling plan, and adjustment and update of the scheduling plan.

Preferably, the implementation method for generation and release of the roster scheduling includes: generating different scheduling shifts by mathematical programming and heuristics algorithms, with the consideration of a series of KPIs, such as coverage rate and working hours; a comparable best scheduling plan is generate and released based on candidate scheduling lists through a cross-comparison of multiple shifts; and the implementation mode for adjustment and update of the scheduling plan is that the scheduling plan is regenerated, added or deleted by manual operation, and released after an adjustment of shift rotation.

Preferably, the functions of the real-time dispatching module include real-time dispatching, time threshold monitoring and alarming.

Preferably, the real-time task dispatching includes an automatic dispatching mode and a manual adjustment dispatching mode; wherein in the automatic dispatching mode, the dispatching system allocates tasks within a given specific time period based on meta-heuristic optimization algorithm, or when assigned tasks have been completed and flight plans change or employees take temporary leave, the dispatching system will reallocate the tasks; in the manual adjustment dispatching mode, a dispatcher may drag unassigned tasks to any on-the-job gate boarding staff and when the unassigned tasks are processed manually, the dispatch system needs to prompt the list of available staffs; the specific implementation mode of the time threshold monitoring and alarming is as follows: for different types of tasks, the dispatching system sets a task automatic release mechanism relative to their reference time points, and sets thresholds of task allocation time, task confirmation time and task start time, and generates notifications and alarms when they are overtime; and the dispatching system will give clear notification and alarm information for task changes and conflicts caused by changes of flight, gate boarding, aircraft stand or staff.

Preferably, the real-time dispatching module also includes functions of task locking and task connection time setting, wherein specific content of the task locking is that the task dispatching system locked on the staff is not automatically adjusted, and if the dispatcher makes manual adjustment, it needs to be unlocked first; and specific content of the task connection time setting is that the dispatching system will allocate tasks according to an advance arrival time and a distance between two task locations, so as to ensure that a connection time between two tasks is enough for the staff to reach the next task locations.

Preferably, the functions of the statistical analysis module include a production of a report and a display of KPI dashboard; the report is produced by a visual reporting tool provided by the dispatching system, and a content of the report relates to task KPI and resource KPI.

More preferably, the operation steps of the task bidline module include: choosing and releasing by the dispatcher, cross-post ground tasks that conform to rules of a ground service center's on-the-job scheme in the dispatching system, and sending by the dispatching system automatically, the tasks to a qualified cross-post employees' hand-held mobile terminal APP according to optimization algorithm results, so the employees may “bid” for such tasks and execute bidding tasks after success.

The beneficial effects of this disclosure are as follows: compared with the traditional ground staff dispatching system, the flight on time performance is higher and the utilization efficiency of staff resources is better; the detailed task statistics of each employee can meet the requirements for information transparency such as labor production efficiency, staff duty fairness, staff work intensity, etc.; through the flow of cross-post resources, it can further improve the utilization of resources, motivate staff, and train multi-skilled and universal ground staff.

### BRIEF DESCRIPTION OF DRAWINGS

FIG. 1 is a business flow chart of a gate boarding service in an embodiment of the present disclosure.

FIG. 2 is a block diagram of the module composition of a dispatching system in the present disclosure.

FIG. 3 is a data flow of gate boarding service in an embodiment of the present disclosure.

### DETAILED DESCRIPTION

The present disclosure will be further described in detail with reference to the drawings and specific embodiments. However, it should not be understood that the scope of the above subject matter of the present disclosure is limited to the following embodiments, and all technologies realized based on the contents of the present disclosure fall within the scope of the present disclosure.

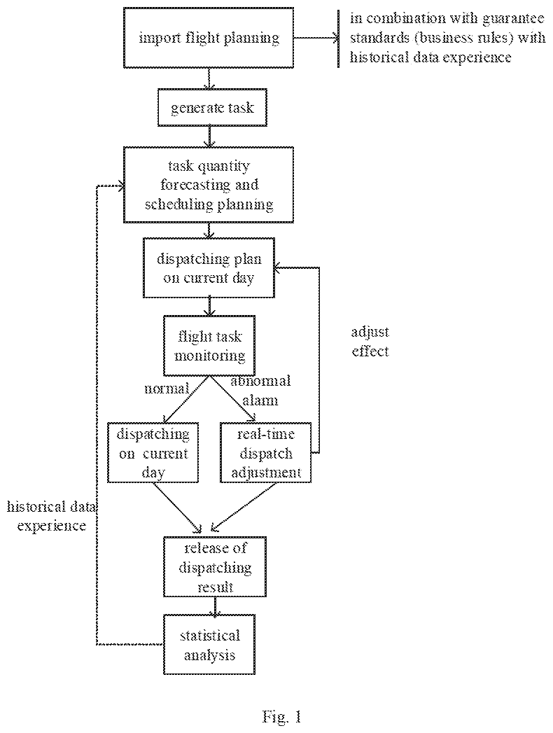

As shown in FIG. 1, the business processes of the dispatching system for gate boarding service provided by the embodiment of the present disclosure include:

importing flight information in combination with demand guarantee standards (business rules) and historical data experience;

generating ground service tasks;

forecasting the overall task quantities and reasonably generate the roster scheduling plan;

generating the dispatching plan for the current day;

performing abnormal monitoring on the flight plan;

correspondingly adjusting the dispatching plan according to the actual feedback of abnormal monitoring;

releasing the task dispatching result; and

statistically analyzing the data and backup as historical data experience.

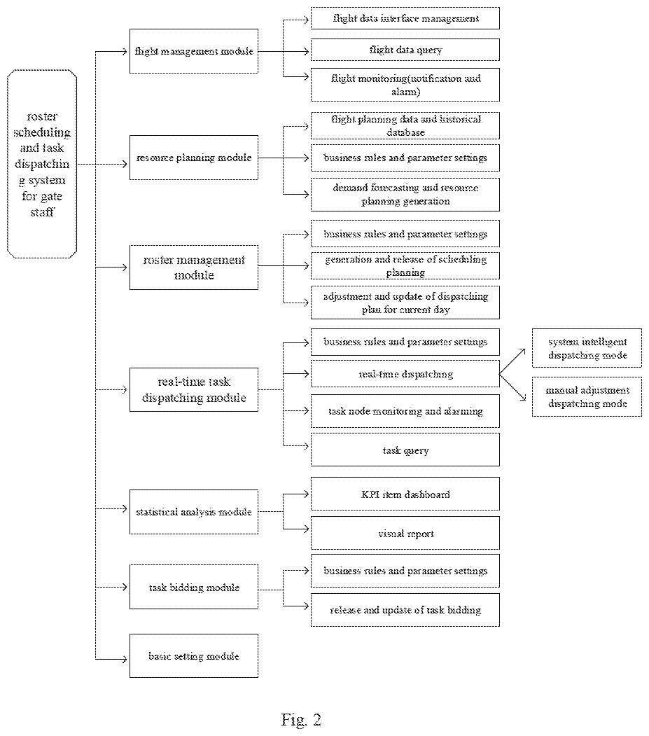

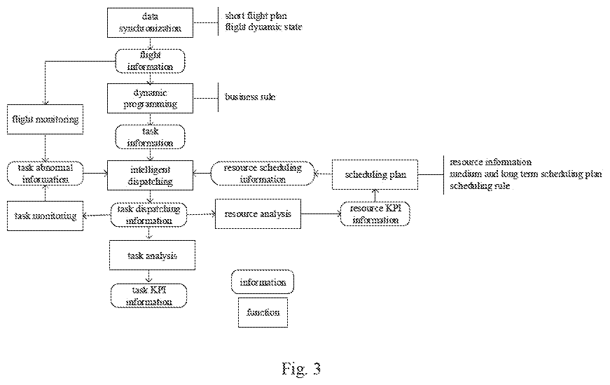

To realize the above business process, a scheduling planning and dispatching system for gate staff is provided, as shown in FIG. 2 and FIG. 3, including a flight management module, a resource planning module, a rostering management module, a real-time task dispatching module, a statistical analysis module and a bidline module.

The flight management module contains the function of flight management, which is configured to adjust gate boarding tasks, filter flight lists, and release notifications and alarms for key flight information changed.

Through the flight data interface of the dispatching system, the full snapshot of flight data may be acquired at the time set by the user, and the incremental change of flight information may also update the flight data in the system. When the flight information changes, the system will automatically adjust the flight-related task information according to the gate boarding task rules. At the same time, if the task has been assigned to gate staff, the system will run the rule engine to check whether the task plan with an updated information is compliant. If it is not compliant, the system will generate alarm and adjust the plan automatically.

Based on the complex query and sorting function of flight information, the dispatching system makes combined query on flight time, departure and arrival airport, airline, gate boarding area, aircraft type, departure and arrival type, flight status, international and domestic information, etc.

The dispatching system may also perform alarm and notification for flight cancellation, delay, flight gate change and flight position change through alarm page and alarm notification bar. At the same time, the system generates an alarm and notification elimination mechanism. Users may locate and process the alarm information through the system, and the alarm is eliminated automatically after the abnormal issue is resolved. At the same time, users may “know” the notification, add comments on the known notification and eliminate the notification.

The resource planning module is configured to forecast and plan the gate boarding tasks and manpower requirements, list and optimize shift plans.

The task dispatching system provides flight plan simulation function, which can automatically generate flight data, automatically complete information and analyze probability etc., based on the historical flight data in a certain period in the future, and provide powerful data support for resource planning. Simulation operation is carried out based on flight data in a certain period, and ground service tasks are generated according to the demand guarantee level and task dispatching operations are carried out according to dispatching rules. Based on the simulation results, the system will analyze and calculate the demand for manpower within the period as well as on the moment and the available resources curve. Through the comparative analysis of the curves, the system will give an early warning to the possible employment gap or the period of rich staffs. The planning operation results of the system are saved separately by scenarios. The scenario data includes flights data, guarantee rules, rostering and dispatching rules, result data, etc. Users can analyze and study the operation results set by different rules through the comparison function of scenario KPIs provided by the system, which may be used as the basis for future scheduling planning.

The rostering module is configured to realize automatic scheduling and management of staff, and has the functions of scheduling rule management, generation and release of the rostering plan, adjustment and update of the rostering plan, static data maintenance, etc.

The implementation mode of the scheduling rule management is as follows:

The dispatching system stores and maintains complete rules about scheduling configuration, which can realize flexible and customized scheduling rule settings. In the system, users can flexibly set constraints through parameter configuration, and these settings are transformed into a set of constraints to optimization model thus ensure the compliance of scheduling solution.

The implementation process of generation and release of the scheduling plan is as follows:

The dispatching system generate different shift patterns by using optimization algorithms such as heuristic algorithms and mathematical programming. The KPIs such as task coverage rate and working hours fairness are considered as the optimization objectives in the optimization model. Users may set the weight parameters or priority of these optimization items to achieve different scheduling optimization objectives. Through the results comparison module of different scenarios of the system, users can conduct the comparative analysis of KPIs and detailed rosters in the solutions under different optimization objectives, and choose satisfactory scheduling results to release. In the system, the scheduling results may be directly exported to the formatted file required by users, and may also be directly pushed to staff through the mobile terminal

The implementation of adjustment and update of the scheduling plan is as follows:

The scheduling results saved in the dispatching system allow users to modify, cancel allocation, and reallocate manually. By modifying the list of employees who work every day in the system calendar, the management of temporary shift adjustment, leave management and temporary leave among employees may be realized. As mentioned earlier, all the modified and updated scheduling results may be output to the text format required by users or pushed and released by mobile APP.

The implementation of static data maintenance is as follows:

The staff list function in the dispatch system can modify and maintain the basic information of staff, delete or add employees and maintain the default shift information of staff. At the same time, planners may carry out more detailed classification management of staff through the “tag” tool provided by the system, so as to meet different business requirements of human resources management.

The real-time dispatching module is configured to perform real-time dispatching of ground staff and task processing, including dispatching rule management, real-time dispatching, task publishing, time threshold monitoring and alarm, and task query.

The implementation mode of the dispatching rule management is as follows:

The dispatching system has a configuration function module of gate boarding task guarantee rules, through which users may configure and maintain the guarantee rules in different dimensions and granularity, and the system automatically generates, modifies and changes the gate boarding tasks of each flight according to the guarantee rules entered by users. Tasks generated by the system will be automatically labeled according to the rules set by the user. At the same time, users can add temporary manual tasks manually through the system and push them to ground staff automatically or manually through the system.

The dispatching optimization model and algorithm considers business rules such as task priority level, qualification requirements and task connection times, which are set as optimization constraints to ensure the satisfaction of business requirements.

There are two kinds of real-time dispatching modes: automatic dispatching mode and manual adjusting dispatching mode.

Under the automatic dispatching mode, the dispatching system allocates tasks in a given specific time period based on the meta-heuristic optimization algorithm. It is also possible to reallocate the assigned tasks when flight plans change or employees take temporary leave. The manual adjustment dispatching mode means that dispatchers can drag and drop unassigned tasks to any on-the-job gate boarding staff. When the unassigned tasks are processed manually, the dispatch system needs to prompt the list of available staff.

The real-time dispatching module in the dispatching system can automatically and efficiently dispatch workers for a period of time. In this module, users can set the time period of real-time dispatching and select staff to participate in dispatching. The system will automatically optimize and calculate the dispatching results according to the user's settings. At the same time, when the flight information changes or the availability of employees changes, the task cohesion in the current plan may be abnormal, and the system will automatically run real-time dispatching operation to solve the task conflict by adjusting the dispatching plan.

On the Gantt operation page, users can manually perform a series of operations: dragging tasks between different employees, dragging tasks from unassigned tasks to an employee, canceling the allocation of a task, etc. After each manual operation, the dispatching system will automatically check the legality of the operation results, and will give an alarm to the illegal operating system.

No matter which of the above modes is used for dispatching, the following functions need to be met:

Task locking: the task dispatching system locked on the staff is not automatically adjusted, and the dispatcher needs to unlock it before manual adjustment.

Task connection time matrix: when assigning tasks, it is necessary to consider the arrival time in advance and the distance between two task locations. The connection time between two tasks of a staff member must be able to ensure enough time for relocation to the next task point.

Users can lock the task on the Gantt operation page of dispatching system. After the task is locked, a lock mark appears on the Gantt for user identification. All locked tasks will not participate in adjustment during automatic dispatching or manual adjustment. Users can unlock the staff allocation of the task by unlocking the operation. In the rule of minimum connection time between tasks, the walking time between task start locations and the early arrival time are considered, to ensure that there is enough time between two consecutive tasks on the same employee during automatic dispatching operation. When users perform manual operation, the system will also check the corresponding rules after each operation. On the Gantt operation page of dispatching system, the visual display of walking time between tasks is added before each task, and users can intuitively see the relationship between walking time and interval between tasks. Meanwhile, the walking time will be dynamically updated in real time with the manual operation of the users.

The dispatching system contains a well-developed fairness mechanism. Factors such as task duration, number of tasks, performance, walking distance and number of special tasks are all bound into fairness evaluation. Users can configure the importance of these fairness factors by adjusting the weight parameters.

Task dispatching results are displayed in the dispatching system by both Gantt and list. Users may export the formatted results as user requirement in the list page and push outside the dispatching system. At the same time, the data results of the system may also be released to employees through the mobile terminal.

There is a configurable dispatching result releasing mechanism in the dispatching system. Users can set the advance releasing time of different types of tasks. At the same time, the system will monitor the confirmation of tasks from the employees. For tasks that are about to start but have not received confirmation, the system will automatically alert the dispatcher to pay attention and manually intervene.

The interaction between the mobile APP and the dispatching system is that the system can integrate with the data interface provided by the airline's mobile APP, and obtain the staff information and geographical location information sent by the mobile APP on time, so as to automatically judge the arrival of employees; the system can push the flight task information to the mobile APP, and receive the timely feedback of employees on the confirmation, start and end of the task at the mobile terminal.

The data interface of the dispatching system releases the following information: the dispatched task information and real-time alarm information. At the same time, the interface receives the real-time information returned by the mobile terminal, including: feedback confirmation after the employee accepts the task, employee positioning information and real-time tracking of task status information. The system will automatically update and save the changes in task information in the system.

The dispatching system has rich ways of querying and viewing tasks to meet different business operation needs. Through the flight list page, users can query the gate task list associated with each flight, and users can manually locate a task on the Gantt page through the “locate button”. Users can query and view the task allocation of each employee through the employee list page. Users can query and locate tasks by entering key information through the query bar on the Gantt operation page, and query the task allocation of other employees who perform tasks for the same flight through a certain task association.

The dispatching system also provides an electronic map top view of the airport and the location of each boarding gate, and can capture and display the real-time task details of the boarding gates and the location of the staff. The information of tasks and staff of each boarding gate at historical time points can be traced back.

All over the electronic map, tasks, staff locations and relevant KPIs are displayed. At the same time, the system generates abnormal alarm based on the location information and task planning information, and all data will be saved as historical data in the system, which is convenient for later data analysis and backtracking.

The dispatching system also provides a static data maintenance page, which includes the following items: airline information, aircraft types and tail numbers, boarding gate, aircraft stands, task generation rule information, task push time interval and task performance weight.

By incorporating general data within the system, users can update and maintain the basic data in the system, and correspondingly the business logic will be automatically updated, which is convenient for users to operate the system.

The statistical analysis module is configured to meet requirements of customized daily report, statistical data query and analysis about the airline ground services.

The dispatching system provides a visual reporting tool, allowing users to customize reports of simple data model, which include task KPI and resource KPI.

In the reports and statistics module, the system displays the data in following dimensions:

quantity statistics of flights according to different flight attributes, types, task types and user-defined task labels;

quantity statistics according to the flight status after the flight is actually executed;

quantity statistics according to the execution of a task type or user-defined task labels;

statistics of employee dimension.

At the same time, users can query and analyze KPI hierarchically and trace back to detailed data through the system.

The dispatching system provides a KPI display dashboard, which displays the following contents:

real-time flight list, real-time flight delay analysis, real-time task number, real-time on-the-job staff number, real-time task duration, real-time shift duration, real-time employee utilization rate and real-time task coverage rate. It can also provide with the dispatcher the overall information about the flight status and task allocation etc. Reports and KPI dashboards can be exported for archive and analysis.

The bidline module is configured to meet requirements of “task bidding” for employees across positions meeting post qualification requirements, and motivates staff.

Under the framework of dispatching system, communications between different business department can be realized, and the business logic of task bidding can be realized through the secondary development and packaging of existing system functions.

In the bidline module, the information of non-gate boarding staff is imported into the system for unified management; based on the task dispatching results of the original business department of non-gate boarding employees, the available time windows that can be used to perform gate boarding tasks can be calculated; and the business rules for non-gate boarding employees to perform gate boarding tasks are maintained.

The detailed steps of task bidding are as follows:

users tags the tasks used for task bidding through the system;

the system automatically filters staff for tasks with bidding labels, and releases information through the mobile terminal;

the staff “bid” through the mobile terminal and transmits the information to the system, and the system completes the “task bidding” allocation after confirmation;

after the successful allocation of “bidding” task, the system will automatically monitor, track, alarm and conduct real-time dispatch adjustment, and automatically save the employee performance information after the task is executed.

In addition, the dispatching system also supports user group access management, which includes at least four groups: administrator, super user, scheduling and dispatching user and employee user.

Herein, the administrator has full authority, the super user has authority to manage basic information and rules, the scheduling dispatching user can use the daily production scheduling function, and the employee user only has authority to query and receive tasks.

It should be noticed that, the modules contained in the roster scheduling and task dispatching system for gate staff may be implemented in softwares, and these softwares may be stored in a storage, and may be performed by a central processing unit (CPU). In other words, the modules contained in the roster scheduling and task dispatching system for gate staff may be instructions in a storage, and may be implemented by a CPU in a terminal, such as a computer, a server and so forth.

The implementation modes of the above-mentioned examples are only used to explain the present disclosure, without imposing restrictions on the present disclosure. Any modifications and changes made to the present disclosure within the spirit and principles of the present disclosure are included in the scope of protection of the present disclosure.

1. A roster scheduling and task dispatching system for gate staff, including:
a flight management module, configured to adjust gate boarding tasks, display flight lists, and provide notification and alarm for an update of key flight information;
a resource planning module, configured to forecast and plan the gate boarding tasks and human resource requirements, display and optimize shift plans;
a roster management module, configured to perform automatic scheduling for resources, improve fairness and rationality of the scheduling and reduce labor intensity and error rate of scheduling personnel through optimization algorithms based on demand of task load and other regulatory constraints;
a real-time task dispatching module, configured to perform real-time adjustment for flight guarantee tasks at gate boarding, and perform real-time task dispatch and compliance inspection for available resources through the optimization algorithms based on flight dynamic data changes and preset guarantee service standards;
a statistical analysis module, configured to meet requirements of the airline ground service in regard to daily report customization, statistical data query and analysis;
a task bidding module, configured to meet requirements of “task bidding” across positions for employees meeting post qualification requirements, and fully mobilize the enthusiasm of employees.

2. The roster scheduling and task dispatching system for gate staff according to claim 1, characterized in that, steps for realizing functions of the flight management module comprise: acquiring by the dispatching system, a full flight data released by the airline on the same day through docking with a ground service data sharing platform of the airline, acquiring incremental data of flight changes once every minute, and automatically adjusting relevant ground tasks according to an judgment of key flight information changes; and providing by the dispatching system, a flight search and positioning tool combining multiple conditions, displaying the flight lists fast and conveniently.

3. The roster scheduling and task dispatching system for gate staff according to claim 1, characterized in that, steps for realizing functions of the resource planning module comprise: reasonably forecasting and planning the gate boarding tasks and human resource requirements in a certain period according to flight scheduling, guarantee standards and historical operation data; forming various roster and shift models according to a demand forecast curve, roster rules and the number of employees, conducting a comparative analysis of shifts through simulation, and displaying and optimizing a shift plan as the roster basis.

4. The roster scheduling and task dispatching system for gate staff according to claim 1, characterized in that, functions of the rostering management module comprise generation and release, adjustment and update of a roster table.

5. The roster scheduling and task dispatching system for gate staff according to claim 4, characterized in that, an implementation for generation and release of the roster table comprises: generating different roster shifts for optimization projects of KPI items, such as coverage rate and working hours by calling optimization algorithms based on heuristic and mathematical programming; comparing multiple shift systems, choose by a scheduling personnel a best roster plan to make a schedule and release; an implementation for adjustment and update of the roster table comprises: releasing the roster table after manual regeneration, addition and deletion, and adjustment of rotation.

6. The roster scheduling and task dispatching system for gate staff according to claim 1, characterized in that, functions of the real-time task dispatching module comprise real-time dispatching, node monitoring and alarming.

7. The roster scheduling and task dispatching system for gate staff according to claim 6, characterized in that, the real-time dispatching comprises a system intelligent dispatching mode and a manual adjustment dispatching mode; wherein in the system intelligent dispatching mode, the dispatching system allocates tasks which have been given specific time period based on meta-heuristic optimization algorithm, or when assigned tasks have been completed, and when flight plans change or employees take temporary leave, the dispatching system will reallocate the tasks; in the manual adjustment dispatching mode, a dispatcher drags unassigned tasks to any on-the-job gate boarding staff and when the unassigned tasks are processed manually, the dispatching system needs to prompt a list of staff to be chosen; a specific implementation of the node monitoring and alarming is as follows: for different types of tasks, the dispatching system sets an automatic task release mechanism relative to its time reference points, and sets thresholds of task allocation time, task confirmation time and task start time; the dispatching system generates notifications and alarms when tasks are overtime, and the dispatching system will give clear notification and alarm information for task changes and conflicts caused by the changes of flight, gate boarding, aircraft stand or staff.

8. The roster scheduling and task dispatching system for gate staff according to claim 7, characterized in that, the real-time dispatching module further comprises functions of task locking and task interval setting, wherein specific content of the task locking is that the task dispatching system locked on the staff is not automatically adjusted, and when the dispatcher makes manual adjustment, he needs to unlock first; and specific content of the task interval setting is that the dispatching system will allocate tasks according to an arrival time ahead of the schedule and a distance between two task locations, so as to ensure that a connection time between the two tasks is enough for the staff to reach a next task point.

9. The roster scheduling and task dispatching system for gate staff according to claim 1, characterized in that, functions of the statistical analysis module comprise a production of a report and a display of KPI dashboard; the report is produced by a visual report making tool provided by the dispatching system, and a content of the report relates to task KPI and resource KPI.

10. The roster scheduling and task dispatching system for gate staff according to claim 1, characterized in that, steps of realizing functions of the task bidding module comprise that: in the dispatching system, choosing by the dispatcher, to release the gate boarding tasks that conform to the rules of the passenger service center's on-the-job scheme across positions, and automatically sending by the dispatching system the tasks to a qualified cross-post employees' hand-held mobile APP according to optimization algorithm results, so that the employees can “bid” for such tasks and execute bidding tasks after success.
